(19) United States
(12) Patent Application Publication
(10) Pub. No.: US 2006/0140475 A1
(43) Pub. Date: Jun. 29, 2006

(54) Network support for corrupting images captured at a prohibited location

(76) Inventors: Frances Mu-Fen Chin, Naperville, IL (US); Peggy Hasan, Aurora, IL (US); Sandra Lynn True, St. Charles, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/013,651

(22) Filed: Dec. 15, 2004

(51) Int. Cl. G06K 9/34; G06K 9/00; H04N 7/14; G05B 9/02

(52) U.S. Cl. 382/164; 700/79; 348/14.01

(57) ABSTRACT

Structures and methods are disclosed for corrupting image files of a mobile image device (e.g., picture phone) in some manner if the image files are initially captured within a designated “no image zone.” The mobile image device queries a wireless telecommunication network upon capturing an image. The network instructs the mobile image device to corrupt the image if it determined to have been captured within a no-image zone. The mobile image device may save the image if it was not captured within a designated “no image” zone.

### CROSS-REFERENCE TO RELATED APPLICATIONS

This invention is related to U.S. patent application Ser. No. ______, titled “Network Support for Image Blocking Based on Location Stamp,” filed concurrently with the present application.

### FIELD OF THE INVENTION

This invention relates generally to wireless telecommunication systems that support image messaging from mobile devices and, more particularly, to a method and apparatus for corrupting images captured from mobile devices within certain “no image” zones.

### BACKGROUND OF THE INVENTION

Communication systems are well known in which mobile devices (e.g., wireless phones) may send and receive messages with other mobile devices or network devices via a wireless telecommunication infrastructure. Depending on the capability of the mobile device, the messages may comprise image information as well as voice or text information. For example, so called “picture phones” including built-in cameras enable a user to take a still photo image, or “picture” of a subject and send it to another mobile device or an e-mail recipient via a telecommunication network. Optionally, the image information may be combined with other data such as text or audio. Further, next-generation phones are coming soon that will have the ability to capture and send streaming video information with other data. For convenience, the term “mobile image device” will be used hereinafter to refer to a mobile device having image processing capability, including but not limited to still photos or streaming video images.

While mobile image devices represent an important technological advance, they raise some problems on the social level. For instance, there is a valid concern that mobile image devices may compromise individuals (or groups) expectations of privacy in certain sensitive areas, such as locker rooms or rooms in which sensitive information of an individual or organization resides. In effect, there is nothing to stop unscrupulous individuals from taking photos or videos at such locations and sending them via the telecommunication network to the Internet, for example, or to virtually any device connected to the telecommunication network. Such images can be captured with relative ease since mobile image devices are relatively small and many can be set to make the shutter click silently, often without detection. Adding insult to injury, the laws generally do not provide adequate penalties to deter the offending party in the event they are discovered.

Related patent application Ser. No. ______ described methods for recognizing and blocking image transmissions sourced from designated “no image zones.” In such manner, a wireless telecommunication network can block the transmission of video and/or photo images from mobile image device(s) (e.g., picture phones) attempting to send images from sensitive locations. However, the related application does not block the storage of images at the mobile device. It is contemplated that unscrupulous users might attempt to capture and store images taken from a “no image” zone and send the images later at such time as the user leaves the “no image zone” to try to avoid blocking of the images; or users may store the images in their mobile device for later retrieval by the device itself or possible download to other storage devices.

Accordingly, there is a need to corrupt image files of a mobile image device in some manner if the image files are initially captured within a designated “no image zone.” In such manner, unscrupulous users will be unable to store images (or at least will not be able to store the uncorrupted images) within their mobile devices. The present invention is directed to addressing this need.

### SUMMARY OF THE INVENTION

The present invention provides structures and methods for corrupting image files of a mobile image device in some manner if the image files are initially captured within a designated “no image zone.”

In one embodiment, there is provided a method performed by a mobile image device performing steps of capturing an image, determining a source location associated with the image, querying a network device to determine whether the source location coincides with a designated no-image zone; and corrupting the image, yielding a corrupted image if the network device indicates that the source location coincides with a designated no-image zone.

In another embodiment, there is provided a mobile image device. The mobile image device comprises a video module and/or camera module for capturing an image, a position determination module for determining a source location associated with the image, an image receptor module for receiving the image and source location, an image gateway module for querying a network device to determine whether the source location of the image coincides with a designated no-image zone; and an image corruption module for corrupting the image, yielding a corrupted image if the source location coincides with a designated no-image zone.

In yet another embodiment, there is provided a method performed by a network device (e.g., MSC) to facilitate corrupting image files within a mobile image device if they are captured within a designated “no image zone.” The MSC receives a query from a mobile image device having captured an image at a source location. Responsive to the query, the MSC consults a database to determine whether the source location coincides with a designated no-image zone. The MSC instructs the mobile image device to corrupt the image, yielding a corrupted image, if the source location is determined to coincide with a designated no-image zone.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which embodiments of the present invention may be implemented;

FIG. 2 is a block diagram of a mobile image device in which embodiments of the present invention may be implemented;

FIG. 3 is a flowchart of a method exercised by a mobile image device to corrupt images captured within a “no image” zone according to an embodiment of the present invention; and

FIG. 4 is a flowchart of a method exercised by a serving MSC to corrupt images captured by mobile image devices within a “no image” zone according to an embodiment of the present invention.

### DESCRIPTION OF THE PREFERRED EMBODIMENT(S)

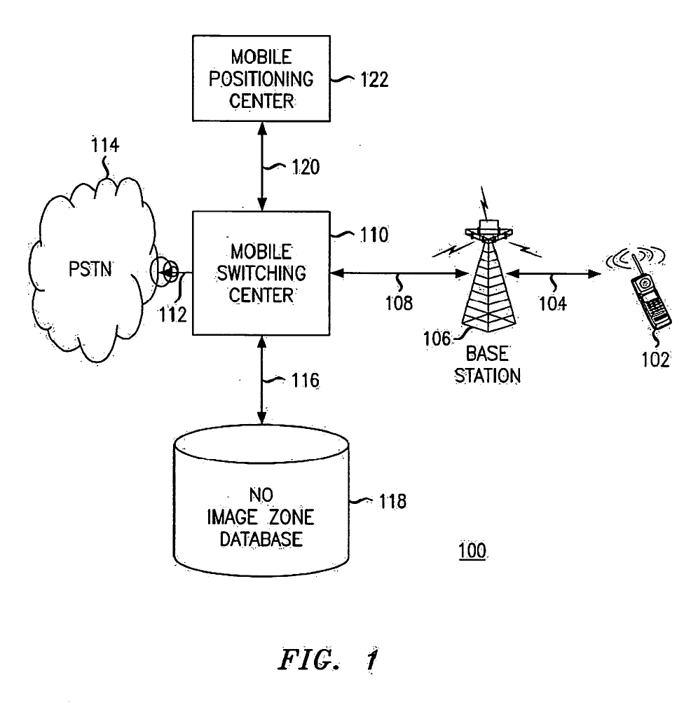

FIG. 1 shows a communication system 100 according to an exemplary embodiment of the invention that is operable to block the attempted capture of images from mobile image devices in designated “no image zones.” A mobile image device 102 is nominally operable to capture and send image information including, but not limited to, still photo images or streaming video information associated with a subject (not shown). The image information may be combined with other data such as text or audio. As will be described in greater detail hereinafter, embodiments of the present invention provide for recognizing whether the image files are captured within a designated “no image zone” and, in such case, to corrupt and prevent storage of the images by the mobile image device.

The mobile image device 102 is connected by wireless link 104 to a base station 106. The wireless link 104 may implement air interface technologies including but not limited to, CDMA, TDMA, GSM, UMTS or IEEE 802.11. The base station 106 is connected by link 108 to a switching element 110 (as shown, a mobile switching center (MSC). The MSC 110 may comprise, for example, an AUTOPLEX™ switching system, available from Lucent Technologies, Inc. The MSC 110 includes a memory and processor (not shown), for storing and executing software routines for processing and switching calls and for providing various call features to calling or called parties. The MSC 110 may be configured for operation with generally any suitable circuit, cell, or packet switching technology. As will be appreciated, the MSC 110 is a functional element that may reside in a single device or may be distributed among multiple devices and/or locations.

The MSC 110 is connected by link 112 to a network 114 (as shown, the Public Switched Telephone Network (PSTN)). The network 114 may be implemented using any appropriate transmission, switching and routing technologies, including but not limited to Internet Protocol (IP) and Asynchronous Transfer Mode (ATM) technologies. As will be appreciated, the network may comprise or may be interconnected with a number of different types of networks including local area networks (LANs), wide area networks (WANs), metropolitan area networks (MANs), the Internet, virtual private networks (VPNs) and/or corporate intranets. In such manner, the MSC 110 may send and receive images and other messages to endless numbers of computers and/or telephony devices residing without limitation, within business enterprises, government and scientific groups, educational and research institutions or private residences.

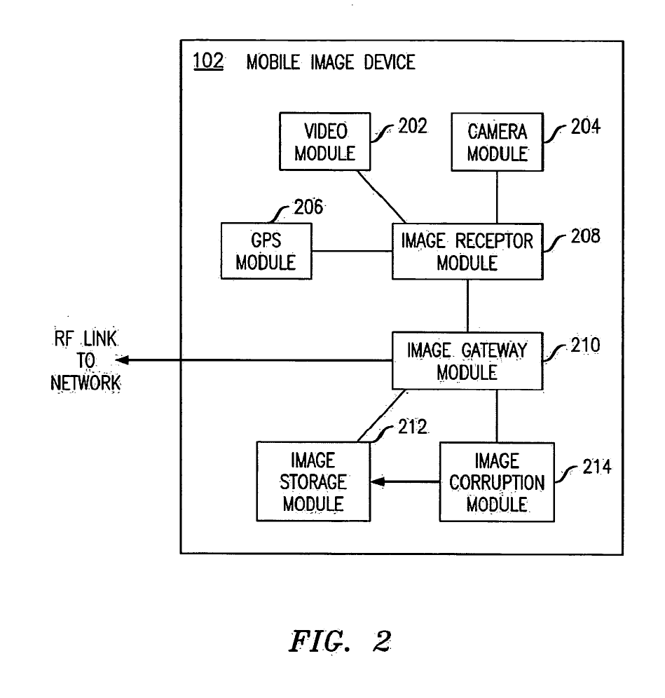

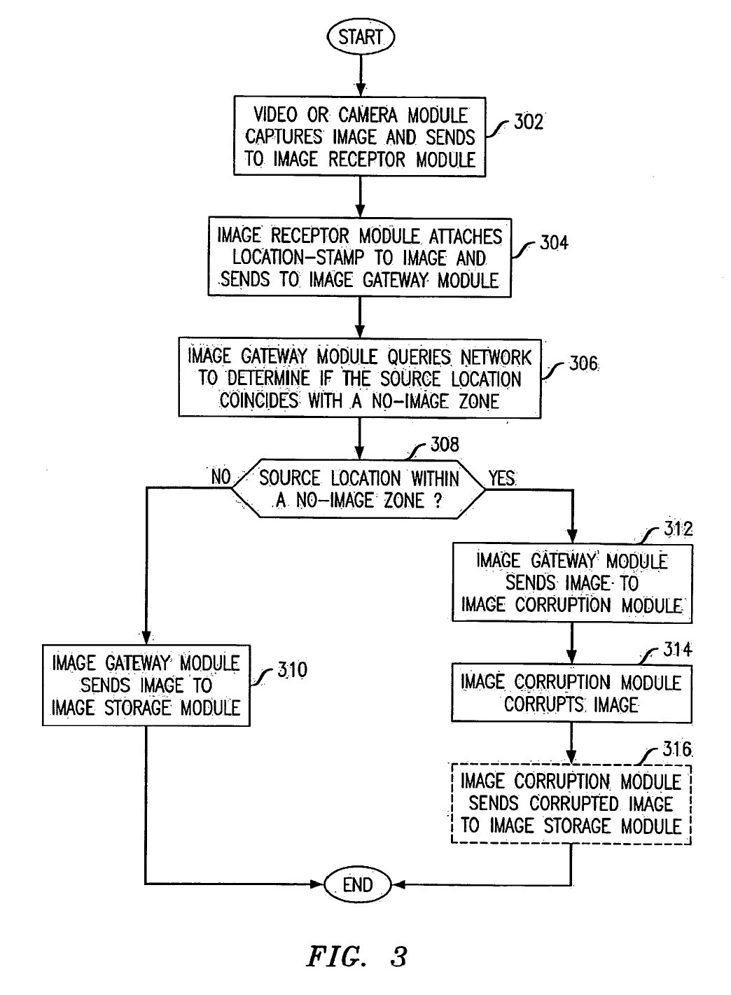

In the exemplary embodiment of FIG. 1, it is presumed that the mobile image device 102 has attempted to capture image information comprising one or more photos or streaming video associated with a subject. The mobile image device need not have attempted to send the information to a called party. In one embodiment as will be described in greater detail in relation to FIG. 2 and FIG. 3, the mobile image device is adapted to query the MSC 110 to determine, based on the source location of the image (i.e., where the image was captured), whether to allow storage of the image or whether to corrupt the image prior to storage so that it may not later be retrieved, downloaded, etc. In one embodiment, the MSC 110 will instruct the mobile image device to corrupt the image data if the sending mobile image device 102 is located within a designated “no image zone.”

In one embodiment, the MSC consults a “no image zone” database 118 to help determine if the image was sourced within a “no image zone” and hence should be corrupted. The MSC is connected to the database 118 by link 116. Link 116 is a logical link that may be physically realized, without limitation, by conventional subscriber lines, Asynchronous Transfer Mode (ATM) lines, ISDN lines, Ethernet LAN or WAN, wireless links, and the like. The “no image zone” database 118 includes location information associated with various designated “no image zones.”

The location information may comprise, for example and without limitation, geo-location information such as latitude, longitude and elevation of various “no image zones.” The location information may indicate, for example, a center point location of various “no image zones.” In one embodiment, the MSC derives boundary information from the center point location. For example, the MSC might consider a particular “no image zone” to extend a threshold radius amount (e.g., 100 feet) from a center point location. Alternatively, the location information itself may include boundary information. For example, the location information might specify a plurality of “corner” points specified by latitude, longitude and elevation; and the MSC extrapolates the corner point locations to derive a geographical boundary of the no-image zones.

The manner of determining which location areas can be considered “no image zones” and how they may be entered in the database is beyond the scope of the present invention. However, it is contemplated that individuals or groups might register certain geo-location area(s) as “no image zone(s)” coincident to a government-managed or privately-managed “no image zone” registry. In such manner, for example, the geo-location of certain locker rooms, corporate offices, government offices and the like may be entered in the no image zone registry and hence, the no image zone database 118.

In one embodiment, the MSC is connected by link 120 to a mobile positioning center 122. The mobile positioning center 122 is a functional element that may reside separately from or within the MSC 110. Link 120 is a logical link that may be physically realized, without limitation, by conventional subscriber lines, Asynchronous Transfer Mode (ATM) lines, ISDN lines, Ethernet LAN or WAN, wireless links, and the like. In one embodiment, the mobile positioning center 122 serves as a position determination entity (PDE) that helps determine the position of various sending devices (e.g., mobile image device 102). The position information is used by the MSC 110 to determine whether or not the source location of the image is within a designated “no image” zone.

As will be appreciated, any of several position determination technologies may be used to determine the position information of the sending devices. These may include, without limitation, global positioning system (GPS) or assisted-GPS (A-GPS) technologies. In the case of A-GPS, the PDE (e.g., mobile positioning center 122) shares assistance data with the mobile image device 202 to enable quicker location determination and greater sensitivity than conventional GPS; the final position calculation may be performed by the mobile positioning center 122 or the mobile image device 102. Alternatively, the mobile image device 102 may calculate its position independently using standard GPS.

In one embodiment, the position information associated with an image source location is provided from the mobile image device 102 to the MSC 110. In one embodiment, the position information is provided in a “location-stamp” appended to messages from the mobile image devices, which messages may or may not include image files. In one embodiment, the mobile image device sends a query message to the MSC coincident to capturing an image, to determine if the image should be corrupted or stored.

FIG. 2 is a block diagram showing functional elements of an exemplary mobile image device 102 according to an embodiment of the present invention. The various functional elements of the mobile image device 102 include: video module 202, camera module 204, GPS module 206, image receptor module 208, image gateway module 210, image storage module 212 and image corruption module 214. In one embodiment, the various modules are implemented in software executed by a processor (not shown) utilizing program instructions stored in memory (not shown). However, as will be appreciated, the functional elements may be in hardware or software or a combination thereof. For convenience, the functional elements will be described in greater detail in relation to FIG. 3.

FIG. 3 is a flowchart of a method exercised by a mobile image device to corrupt images captured within a “no image” zone according to an embodiment of the present invention. The steps of FIG. 3 are implemented by the various functional elements shown in FIG. 2.

At step 302, the video or camera module 202, 204 takes a video stream or picture, respectively, of a subject so as to capture an image of the subject, at least temporarily (i.e., the image may be eventually corrupted as will be described) and sends the image to the image receptor module 208. At step 304, the image receptor module 208 attaches a “location-stamp” to the image so as to identify the source location of the image and sends the image with source location information to the image gateway module 210. The image receptor module receives source location information from the GPS module 206.

At step 306, the image gateway module 210 queries the network to determine if the source location of the image coincides with a no-image zone. For example, referring to FIG. 1, the image gateway module sends the source location information to the MSC 110, which compares the source location against various no-image zones registered in the database 118. In one embodiment, the MSC instructs the image gateway module to corrupt the image if it determines that the source location corresponds with a no-image zone. If the MSC determines that the source location is not within a no-image zone, the MSC may send a message informing the image gateway module that the source location is permissible; or optionally may not respond to the query—in which the case the image gateway module interprets the lack of response as indicia that the image file need not be corrupted.

At step 308, the image gateway module makes a decision on how to further process the image based on whether the image source location is indicated by the MSC 110 to correspond with a no-image zone. If the image source location is indicated to be permissible (i.e., not within a no-image zone), the image gateway module at step 310 sends the image to the image storage module 212. In such manner, a verified image is stored in the image storage module 212 and may be later retrieved, downloaded or sent to a recipient in the network as may be desired.

If the image source location is indicated to be within a no-image zone, the image gateway module at step 312 sends the image to the image corruption module 212. The image corruption module corrupts the image at step 314. For example, the image corruption module may cause the image to be “scrambled” or erased entirely. As will be appreciated, the image corruption module may be implemented in several ways yielding different characteristics of the corrupted image. The particular manner in which the image is corrupted is beyond the scope the present invention. Suffice it to say that the image corruption module yields an image that is corrupted or compromised in some manner so that the original image is imperceptible, obscured or destroyed. Optionally, at step 316, the image corruption module may send the corrupted image to the image storage module.

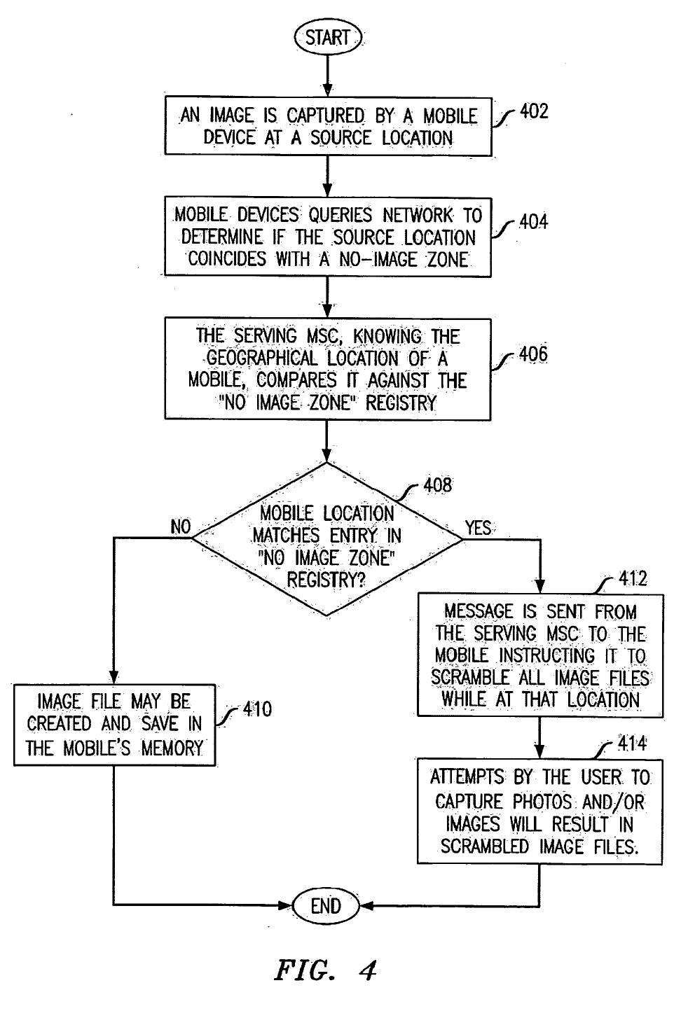

FIG. 4 is shown a flowchart showing complementary steps exercised by the network (e.g., a serving MSC 110) to cause images captured by mobile image devices within “no image” zones to become corrupted. The method presumes at step 402, that a mobile image device captures an image at a source location; and, at step 404, the mobile image device queries the network to determine if the source location coincides with a no-image zone. At step 406, the MSC 110 receives the query and compares the source location of the image against the “no image zones” registered in the “no image zone” database 118.

At step 408, the MSC 110 makes a decision whether or not to instruct the mobile image device to corrupt the image based on the comparison of the source location against the “no image zone” registry. If the source location does not match any of the designated “no-image” zones in the database 118, the MSC at step 410 allows the mobile image device to save the image file, in uncorrupted form, in its memory. Step 410 may be implemented by sending a message to the mobile image device indicating affirmatively that the image file may be stored; or optionally the MSC may not respond to the query—in which the case the mobile image device interprets the lack of response as indicia that the image file may be stored in uncorrupted form.

If the MSC determines that the image source location coincides with a no-image zone, the MSC instructs the mobile image device at step 412 to “scramble” or corrupt the image in some manner so that the original image is imperceptible, obscured or destroyed. Thereafter, as indicated by step 414, further attempts by the user to retrieve the image files will result in scrambled or imperceptible image files.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising a mobile image device performing steps of:
capturing an image;
determining a source location associated with the image;
querying a network device to determine whether the source location coincides with a designated no-image zone; and
corrupting the image, yielding a corrupted image if the network device indicates that the source location coincides with a designated no-image zone.

2. The method of claim 1, further comprising the step of saving the image if the network device does not indicate that the source location coincides with a designated no-image zone.

3. The method of claim 1, further comprising the step of saving the image if the network device indicates that the source location does not coincide with a designated no-image zone.

4. A mobile image device comprising:
at least one of a video module and camera module for capturing an image;
a position determination module for determining a source location associated with the image;
an image receptor module for receiving the image and source location;
an image gateway module for querying a network device to determine whether the source location of the image coincides with a designated no-image zone; and
an image corruption module for corrupting the image, yielding a corrupted image if the source location coincides with a designated no-image zone

5. The mobile image device of claim 4, further comprising an image storage module for saving the image if the source location does not coincide with a designated no-image zone.

6. A method, performed by a network device, comprising the steps of:
receiving a query from a mobile image device having captured an image at a source location,
responsive to the query, consulting a database to determine whether the source location coincides with a designated no-image zone; and
instructing the mobile image device to corrupt the image, yielding a corrupted image, if the source location is determined to coincide with a designated no-image zone.

7. The method of claim 6, further comprising the step of instructing the mobile image device not to corrupt the image if the source location is not determined to coincide with a designated no-image zone.

8. The method of claim 6, wherein the network device refrains from instructing the mobile image device to corrupt the image if the source location is not determined to coincide with a designated no-image zone.

9. The method of claim 6, wherein the network device comprises a mobile switching center (MSC).
